(19) United States
(12) Patent Application Publication
(10) Pub. No.: US 2010/0215463 A1
(43) Pub. Date: Aug. 26, 2010

(54) Carrying Apparatus Capable of Quickly Moving a Positioning Platform Carried by it

(76) Inventors: Chi-Pin CHOU, Taichung (TW); Ming-Hung HSIEH, Taichung (TW)

Correspondence Address: Dr. BANGER SHIA;Patent Office of Bang Shia, 102 Lindencrest Ct., Sugar Land, TX, 77479-5201, US

(21) Appl. No.: 12/390,478

(22) Filed: Feb. 22, 2009

(51) Int. Cl. B65G 65/02

(52) U.S. Cl. 414/279

(57) ABSTRACT

A carrying apparatus capable of quickly moving a positioning platform carried by it is provided with a positioning platform at the top thereof and a support base at the bottom thereof. The carrying apparatus is defined with at least one sliding way, and the positioning platform is provided with a plurality of wheels which is in rolling contact with the sliding way of the carrying apparatus, so as to make the positioning platform move in the sliding way of the carrying apparatus quickly.

### BACKGROUND OF THE INVENTION

1. Field of the Invention

The present invention relates to a carrying apparatus for carrying a platform, and more particularly to a carrying apparatus capable of quickly moving a positioning platform carried by it.

2. Description of the Prior Art

During assembly of a positioning platform on the customer's site, once the positioning platform needs to move into the customer's equipment, it should use a gantry crane to hoist the positioning platform and then move it slowly into the equipment. However, the positioning platform is always bulky and must be manually moved if there is no such a gantry crane at the worksite. Moreover, using the gantry crane is likely to cause deformation of the positioning platform.

The present invention has arisen to mitigate and/or obviate the afore-described disadvantages.

### SUMMARY OF THE INVENTION

The primary objective of the present invention is to provide a carrying apparatus capable of quickly moving a positioning platform carried by it.

To achieve the objective of the present invention, the carrying apparatus capable of quickly moving a positioning platform carried by it is defined with a sliding way in the top thereof and is provided with a support base at the bottom thereof, and the positioning platform is provided with a plurality of wheels which is movably disposed in the sliding ways. At both lateral sides of the carrying apparatus are provided a plurality of auxiliary members, respectively. The respective auxiliary members comprise an assembly portion and a stopping portion. The assembly portions of the auxiliary members are fixed to the lateral side of the carrying apparatus, so as to restrict the wheels of the positioning platform.

At both lateral sides of the carrying apparatus are provided a plurality of anti-deviation structures. The respective anti-deviation structures comprise a support member and a restriction member. The support member has one end fixed to one of the lateral sides of the carrying apparatus and the other end fixed with one end of the restriction member which has the other end faced to one lateral side of the positioning platform, so as to restrict the positioning platform.

It is apparent from the above-mentioned descriptions that the present invention has the advantage that the positioning platform utilizes the wheels to move in the sliding ways of the carrying apparatus, so as to make the positioning platform move on the carrying apparatus quickly.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a carrying apparatus capable of quickly moving a positioning platform carried by it in accordance with the present invention;

FIG. 2 is a plane view of the carrying apparatus capable of quickly moving a positioning platform carried by it in accordance with the present invention; and

FIG. 3 is a partial enlarged view of the carrying apparatus capable of quickly moving a positioning platform carried by it in accordance with the present invention.

### DETAILED DESCRIPTION OF THE PREFERRED EMBODIMENTS

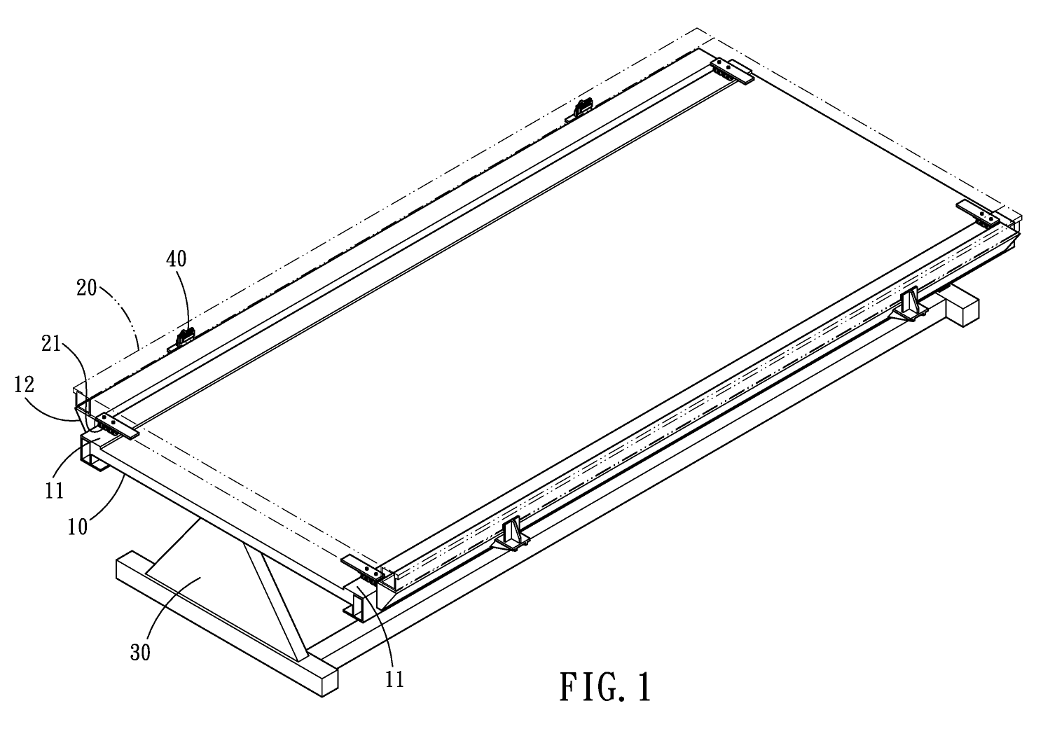

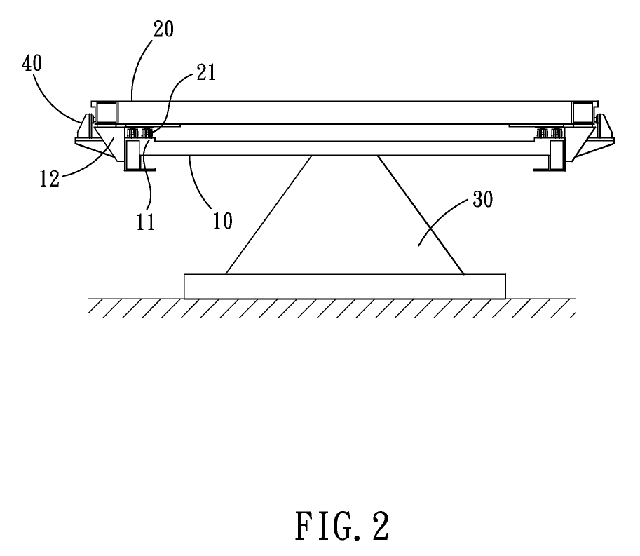

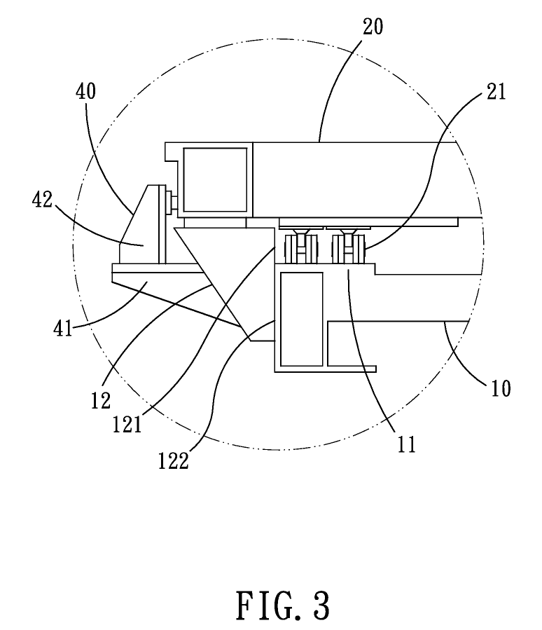

Referring to FIGS. 1-3, a carrying apparatus 10 in accordance with the present invention is shown, on the top of the carrying apparatus 10 is carried a positioning platform 20, at the bottom of the carrying apparatus 10 is provided a support base 30, and at both lateral sides of the carrying apparatus 10 are provided an anti-deviation structure 40, respectively.

At both sides of the top surface of the carrying apparatus 10 are defined a sliding way 11, respectively. At both lateral sides of the carrying apparatus 10 are provided an auxiliary member 12 having an assembly portion 121 and a stopping portion 122, respectively. The assembly portion 121 is located at one side of the stopping portion 122 and is screwed on one of the lateral sides of the carrying apparatus 10 by screws. The auxiliary member 12 uses its top surface which is higher than the carrying apparatus 10 to cooperate with the positioning platform 20.

At both sides of the bottom surface of the positioning platform 20 are provided two wheels 21, respectively, in such a manner that the wheels 21 are in rolling contact with the sliding ways 11 of the carrying apparatus 10. The stopping portion 122 of the auxiliary member 12 is faced to the wheels 21 of the positioning platform 20, so as to restrict the positioning platform 20 and make it move on the carrying apparatus 10 stably.

Each anti-deviation structure 40 comprises a support member 41 and a restriction member 42. The support member 41 has one end screwed on one of the lateral sides of the carrying apparatus 10 by screws and the other end screwed with one end of the restriction member 42 which has the other end faced to one lateral side of the positioning platform 20, so as to restrict the positioning platform 20.

While we have shown and described various embodiments in accordance with the present invention, it should be clear to those skilled in the art that further embodiments may be made without departing from the scope of the present invention.

What is claimed is:

1. A carrying apparatus capable of quickly moving a positioning platform carried by it, comprising:
at least one sliding way defined in a top surface of the carrying apparatus;
a positioning platform provided with a plurality of wheels on a bottom surface thereof, the wheels of the positioning platform being in rolling contact with the sliding way of the carrying apparatus;
a support base provided at a bottom of the carrying apparatus; and
a plurality of auxiliary members provided at both lateral sides of the carrying apparatus, the respective auxiliary members having an assembly portion and a stopping portion, the assembly portions of the auxiliary members being detachably assembled to the lateral sides of the carrying apparatus, so as to restrict the wheels of the positioning platform by the stopping portions of the auxiliary members.

2. The carrying apparatus capable of quickly moving a positioning platform carried by it as claimed in claim 1, wherein a plurality of anti-deviation structures is provided at the lateral sides of the carrying apparatus, the respective anti-deviation structures comprise a support member and a restriction member, the support member has one end detachably assembled to one of the lateral sides of the carrying apparatus and the other end fixed with one end of the restriction member which has the other end faced to one lateral side of the positioning platform, so as to restrict the positioning platform.
